(19) United States
(12) Patent Application Publication
(10) Pub. No.: US 2026/0094849 A1
(43) Pub. Date: Apr. 2, 2026

(54) FUEL CELL STACK

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Akihiro INUKAI, Okazaki-shi (JP); Kensuke DOI, Obu-shi (JP)

(73) Assignee: TOYOTA BOSHOKU KABUSHIKI KAISHA, Aichi-ken (JP)

(21) Appl. No.: 19/343,578

(22) Filed: Sep. 29, 2025

(30) Foreign Application Priority Data
Oct. 2, 2024 (JP) 2024-173433

(51) Int. Cl. H01M 8/0267; H01M 8/0254; H01M 8/0263; H01M 8/04029; H01M 8/1004; H01M 8/2457

(52) U.S. Cl. CPC H01M 8/0267; H01M 8/0254; H01M 8/0263; H01M 8/04029; H01M 8/2457; H01M 8/1004

(57) ABSTRACT

A fuel cell stack includes multiple stacked single cells. Each single cell includes a power generation portion, a first separator, and a second separator. Each single cell includes a cooling medium supplying hole at an end portion on one side in a first direction and a cooling medium discharging hole at an end portion on the other side in the first direction. The first separator includes grooves and ridges that form multiple meandering first passages. The second separator includes grooves and ridges that form multiple meandering second passages. Reversing sections of the first passages and reversing sections of the second passages extend to be inclined with respect to a second direction. The reversing sections of the first passages and the reversing sections of the second passages overlap with each other so as to intersect with each other between the cooling medium supplying hole and the cooling medium discharging hole.

### CROSS-REFERENCE TO RELATED APPLICATIONS

This application is based upon and claims the benefit of priority from Japanese Patent Application No. 2024-173433, filed on Oct. 2, 2024, the entire contents of which are incorporated herein by reference.

### BACKGROUND

### 1. Field

The present disclosure relates to a fuel cell stack including multiple stacked single cells.

### 2. Description of Related Art

JP2010-55857A discloses a typical example of a fuel cell stack. Such a fuel cell stack is formed by stacking multiple single cells. Each single cell is formed by sandwiching an electrolyte membrane electrode structure between an anode-side metal separator and a cathode-side metal separator. The single cell as a whole has the shape of a rectangular plate.

One end in the long-side direction of each single cell is provided with an oxidant gas inlet hole, to which oxidant gas is supplied, a cooling medium outlet hole, through which cooling medium is discharged, and a fuel gas outlet hole, through which fuel gas is discharged. The other end in the long-side direction of the single cell is provided with a fuel gas inlet hole, to which fuel gas is supplied, a cooling medium inlet hole, to which cooling medium is supplied, and an oxidant gas outlet hole, through which oxidant gas is discharged.

The anode-side metal separator includes grooves and corresponding ridges integrally formed on the opposite sides, and the grooves and ridges define fuel gas passages on the surface facing the electrolyte membrane electrode structure. The fuel gas passages are connected to the fuel gas inlet hole and the fuel gas outlet hole. The fuel gas passages form meandering passages (serpentine passages) that include reversing sections extending linearly in the short-side direction of the single cell.

The cathode-side metal separator includes grooves and corresponding ridges integrally formed on the opposite sides, and the grooves and ridges define oxidant gas passages on the surface facing the electrolyte membrane electrode structure. The oxidant gas passages are connected to the oxidant gas inlet hole and the oxidant gas outlet hole. The oxidant gas passages form meandering passages that include reversing sections extending linearly in the short-side direction of the single cell.

A cooling medium flow region, through which cooling medium flows, is formed between the anode-side metal separator of one of two single cells adjacent to each other in the staking direction and the cathode-side metal separator of the other single cell. This region communicates with the cooling medium inlet hole and the cooling medium outlet hole, which are disposed opposite to each other in the long-side direction.

In the above-described fuel cell stack, the reversing sections of the fuel gas passages on the anode-side metal separator of one of two single cells adjacent to each other in the stacking direction overlap with the reversing sections of the oxidant gas passages on the cathode-side metal separator of the other single cell. Specifically, the respective reversing sections of the fuel gas passages and the oxidant gas passages, which are formed by grooves and ridges, extend linearly in the short-side direction and overlap in parallel alignment in the cooling medium flow region between the cooling medium inlet hole and the cooling medium outlet hole.

This configuration impedes flow of cooling medium between the cooling medium inlet hole and the cooling medium outlet hole in the cooling medium flow region. In other words, the cooling medium flow region includes a section in which the cooling medium flows smoothly and a section in which the cooling medium does not flow smoothly. Consequently, the effectiveness of cooling by the cooling medium varies significantly across each single cell.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell stack includes multiple stacked single cells. Each of the single cells has a shape of a rectangular plate with a first side and a second side that are orthogonal to each other, and includes a power generation portion, a first separator and a second separator. The first separator and the second separator sandwich the power generation portion. Each of the single cells includes a first hole, a second hole, a third hole, a fourth hole, a fifth hole, and a sixth hole. The first hole, the second hole, and the third hole are at an end portion on one side in a first direction. The first direction is a direction in which the first side extends. The fourth hole, the fifth hole, and the sixth hole are at an end portion on an other side in the first direction. The first hole, the second hole, and the third hole are arranged in that order from one side to the other side in a second direction. The second direction is a direction in which the second side extends. The fourth hole, the fifth hole, and the sixth hole are arranged in that order from the one side to the other side in the second direction. One of the first hole and the sixth hole is a fuel gas supplying hole to which fuel gas is supplied, and the other is a fuel gas discharging hole through which the fuel gas is discharged. One of the third hole and the fourth hole is an oxidant gas supplying hole to which oxidant gas is supplied, and the other is an oxidant gas discharging hole through which the oxidant gas is discharged. One of the second hole and the fifth hole is a cooling medium supplying hole to which a cooling medium is supplied, and the other is a cooling medium discharging hole through which the cooling medium is discharged. The first separator includes grooves and ridges integrally formed on opposite sides. The grooves and ridges define meandering first passages in which a flow of the oxidant gas is reversed multiple times. The first passages extend from the oxidant gas supplying hole to the oxidant gas discharging hole and supply the oxidant gas to a surface on one side of the power generation portion. The second separator includes grooves and ridges integrally formed on opposite sides. The grooves and ridges define meandering second passages in which a flow of the fuel gas is reversed multiple times. The second passages extend from the fuel gas supplying hole to the fuel gas discharging hole and supply the fuel gas to a surface on an other side of the power generation portion. A cooling medium flow region through which the cooling medium flows from the cooling medium supplying hole toward the cooling medium discharging hole is formed between the first separator of one of two single cells adjacent to each other in a stacking direction and the second separator of the other of the two single cells. The first passages each include a reversing section, and the second passages each include a reversing section. The reversing sections of the first passages and the reversing sections of the second passages extend to be inclined with respect to the second direction. When viewed from the stacking direction, the reversing sections of the first passages and the reversing sections of the second passages overlap with each other so as to intersect with each other between the cooling medium supplying hole and the cooling medium discharging hole, which are disposed opposite to each other in the first direction.

Other features and aspects will be apparent from the following detailed description, the drawings, and the claims.

### BRIEF DESCRIPTION OF THE DRAWINGS

FIG. 1 is a schematic cross-sectional view of a fuel cell according to an embodiment.

FIG. 2 is an exploded perspective view of a single cell.

FIG. 3 is a plan view of a fuel cell stack.

FIG. 4 is a cross-sectional view of grooves and ridges that form first passages of a first separator and second passages of a second separator.

FIG. 5 is a plan view of a fuel cell stack according to a modification.

FIG. 6 is a plan view of a fuel cell stack according to another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

### Fuel Cell 11

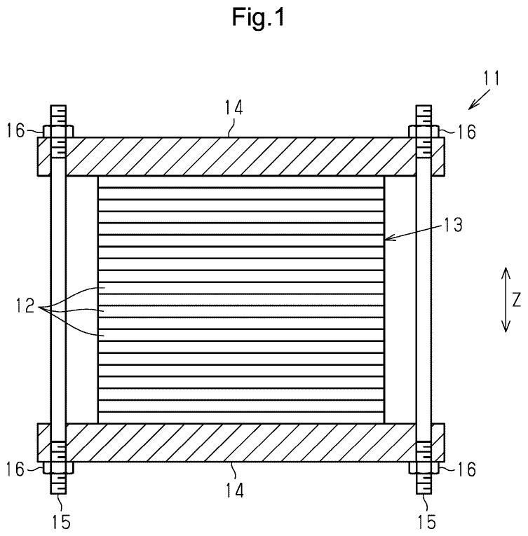

As shown in FIG. 1, a fuel cell 11 includes a fuel cell stack 13 and two end plates 14. The fuel cell stack 13 includes rectangular plate-shaped single cells 12, each generating power. The single cells 12 are stacked in their thickness direction Z. The two end plates 14 sandwich the fuel cell stack 13 from the opposite sides in the thickness direction Z of the single cells 12. In the present example, the thickness direction Z of the single cells 12 agrees with the stacking direction of the single cells 12.

The two end plates 14 compress the fuel cell stack 13 in the thickness direction Z of the single cells 12 by being fastened together at their outer edge portions using bolts 15 and nuts 16. A terminal plate (not shown), which collects electric current, and an insulating plate (not shown), which provides electrical insulation, are interposed between each end plate 14 and the fuel cell stack 13.

### Single Cell 12

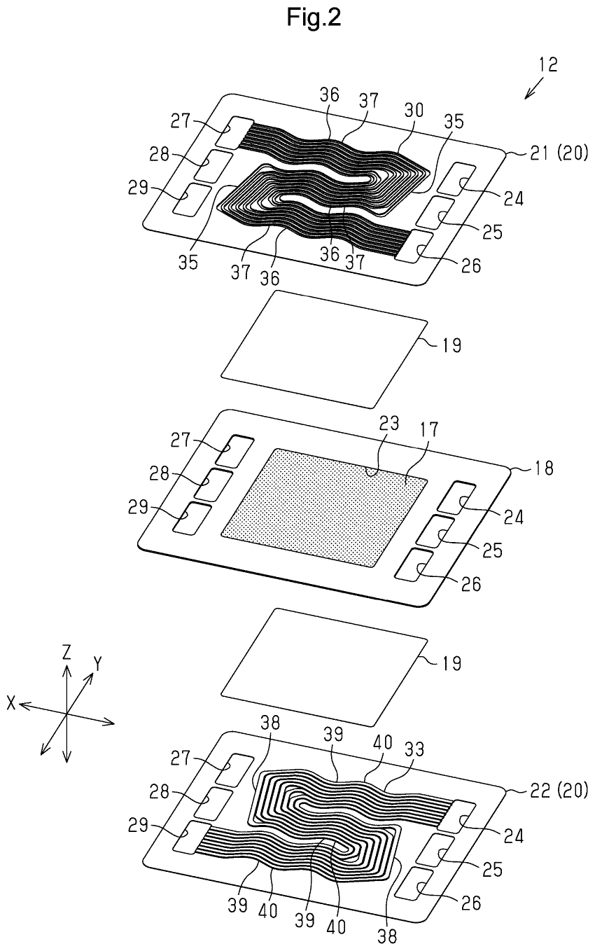

As shown in FIG. 2, each single cell 12 includes a rectangular plate-shaped support frame 18, two rectangular sheet-shaped gas diffusion layers 19, and two rectangular plate-shaped metal separators 20. The support frame 18 supports a rectangular sheet-shaped power generation portion 17. The gas diffusion layers 19 sandwich the power generation portion 17. The separators 20 sandwich the support frame 18, which supports the power generation portion 17 held between the gas diffusion layers 19.

The two separators 20 include a first separator 21 disposed on the cathode side, and a second separator 22 disposed on the anode side. The power generation portion 17 is supported while being accommodated in a rectangular opening 23 formed in a central portion of the support frame 18. The power generation portion 17 includes a membrane electrode assembly (MEA).

In the present example, first sides and second sides orthogonal to each other in each single cell 12, which has the shape of a rectangular plate, are long sides and short sides, respectively. In the following description, a long-side direction, a short-side direction, and a thickness direction of the single cell 12 are referred to as a long-side direction X as an example of a first direction, in which the long sides extend, a short-side direction Y as an example of a second direction in which the short sides extend, and a thickness direction Z, respectively. The long-side direction X, the short-side direction Y, and the thickness direction Z are orthogonal to each other.

### Passage Configuration in the Single Cell 12

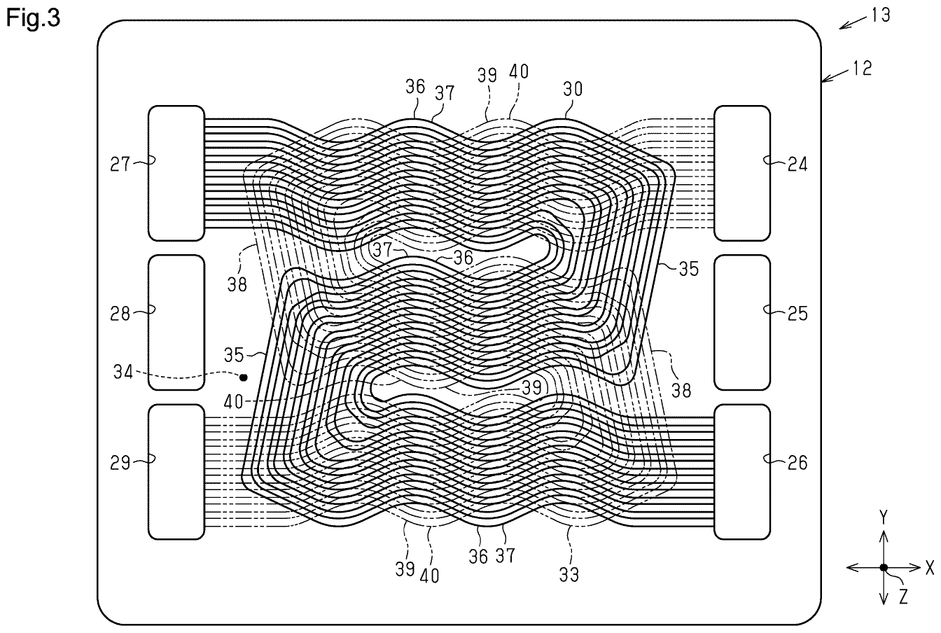

As shown in FIGS. 2 and 3, each single cell 12 includes a fuel gas supplying hole 24, a cooling medium discharging hole 25, and an oxidant gas discharging hole 26 at an end portion on one side in the long-side direction X. The fuel gas supplying hole 24 is an example of a first hole, to which fuel gas is supplied. The cooling medium discharging hole 25 is an example of a second hole, through which cooling medium is discharged. The oxidant gas discharging hole 26 is an example of a third hole, through which oxidant gas is discharged. The fuel gas supplying hole 24, the cooling medium discharging hole 25, and the oxidant gas discharging hole 26 are arranged in that order from one side to the other side in the short-side direction Y of the single cell 12.

The single cell 12 includes an oxidant gas supplying hole 27, a cooling medium supplying hole 28, and a fuel gas discharging hole 29 at an end portion on the other side in the long-side direction X. The oxidant gas supplying hole 27 is an example of a fourth hole, to which oxidant gas is supplied. The cooling medium supplying hole 28 is an example of a fifth hole, to which cooling medium is supplied. The fuel gas discharging hole 29 is an example of a sixth hole through which the fuel gas is discharged. The oxidant gas supplying hole 27, the cooling medium supplying hole 28, and the fuel gas discharging hole 29 are arranged in that order from one side to the other side in the short-side direction Y of the single cell 12.

Fuel gas containing, for example, hydrogen is supplied to the fuel gas supplying hole 24. The fuel gas is discharged from the fuel gas discharging hole 29. Oxidant gas containing, for example, oxygen is supplied to the oxidant gas supplying hole 27. The oxidant gas is discharged from the oxidant gas discharging hole 26. A cooling medium, such as cooling water, is supplied to the cooling medium supplying hole 28. The cooling medium is discharged from the cooling medium discharging hole 25.

The fuel gas supplying hole 24 and the oxidant gas supplying hole 27 are disposed opposite to each other in the long-side direction X. The oxidant gas discharging hole 26 and the fuel gas discharging hole 29 are disposed opposite to each other in the long side direction X. The cooling medium discharging hole 25 and the cooling medium supplying hole 28 are disposed opposite to each other in the long-side direction X.

The fuel gas supplying holes 24, the fuel gas discharging holes 29, the oxidant gas supplying holes 27, the oxidant gas discharging holes 26, the cooling medium supplying holes 28, and the cooling medium discharging holes 25 of the single cells 12 respectively form a manifold extending in the thickness direction Z in the fuel cell stack 13.

### Separators 20

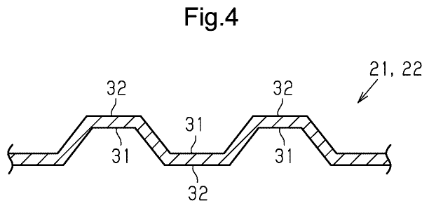

As shown in FIGS. 2 to 4, the first separator 21 includes multiple first passages 30 on the surface facing the power generation portion 17 to connect the oxidant gas supplying hole 27 to the oxidant gas discharging hole 26. The first passages 30 supply the oxidant gas to the surface on one side of the power generation portion 17, while allowing the oxidant gas to flow therethrough from the oxidant gas supplying hole 27 to the oxidant gas discharging hole 26. The first passages 30 are defined by grooves and corresponding ridges that are integrally formed on the opposite sides of the first separator 21 by a pressing process. In the present embodiment, the grooves and ridges that form the first passages 30 of the first separator 21 each have a trapezoidal shape in a cross-sectional view.

The grooves and ridges of the first separator 21 include grooves 31 that face the power generation portion 17 and form the first passage 30. The grooves 31 forming the first passages 30 extend in parallel at regular intervals. The first separator 21 includes ridges 32 each formed between two of the grooves 31. The grooves and ridges of the first separator 21 are formed such that a groove 31 on one surface corresponds to a ridge 32 on the opposite surface, and a ridge 32 on one surface corresponds to a groove 31 on the opposite surface.

The grooves and ridges on the first separator 21 are arranged such that the grooves 31 and the ridges 32 are alternately arranged at equal intervals in the arrangement direction of the first passages 30. The first passages 30 in the first separator 21 extend in a meandering manner such that the flow direction of the oxidant gas is reversed multiple times (twice in the present example). That is, the first passages 30 are so-called serpentine passages.

As shown in FIGS. 2 to 4, the second separator 22 includes multiple second passages 33 on the surface facing the power generation portion 17 to connect the fuel gas supplying hole 24 to the fuel gas discharging hole 29. The second passages 33 supply the fuel gas to the surface on the other side of the power generation portion 17 (the surface on the side opposite to the first separator 21), while allowing the fuel gas to flow therethrough from the fuel gas supplying hole 24 to the fuel gas discharging hole 29. The second passages 33 are defined by grooves and corresponding ridges that are integrally formed on the opposite sides of the second separator 22 by a pressing process. In the present embodiment, the grooves and ridges that form the second passage 33 of the second separator 22 each have a trapezoidal shape in a cross-sectional view.

The grooves and ridges of the second separator 22 include grooves 31 that face the power generation portion 17 and form the second passage 33. The grooves 31 forming the second passages 33 extend in parallel at regular intervals. The second separator 22 includes ridges 32 each formed between two of the grooves 31. The grooves and ridges of the second separator 22 are formed such that a groove 31 on one surface corresponds to a ridge 32 on the opposite surface, and a ridge 32 on one surface corresponds to a groove 31 on the opposite surface.

The grooves and ridges on the second separator 22 are arranged such that the grooves 31 and the ridges 32 are alternately arranged at equal intervals in the arrangement direction of the second passages 33. The second passages 33 in the second separator 22 extend in a meandering manner such that the flow direction of the fuel gas is reversed multiple times (twice in the present example). That is, the second passages 33 are so-called serpentine passages.

As shown in FIGS. 2 and 3, the first separator 21 and the second separator 22 have an identical configuration. In each single cell 12, the first separator 21 and the second separator 22 are arranged such that one is disposed in a front-rear reversed orientation with respect to the other. In this arrangement, when viewed in the thickness direction Z, the fuel gas supplying holes 24, the fuel gas discharging holes 29, the oxidant gas supplying holes 27, the oxidant gas discharging holes 26, the cooling medium supplying holes 28, and the cooling medium discharging holes 25 of the first and second separators 21, 22 are aligned with one another.

### Fuel Cell Stack 13

As shown in FIGS. 1 to 3, in the fuel cell stack 13, a cooling medium flow region 34, in which the cooling medium flows from the cooling medium supplying hole 28 toward the cooling medium discharging hole 25, is formed between the first separator 21 of one of two single cells 12 adjacent to each other in the thickness direction Z (staking direction) and the second separator 22 of the other single cell 12.

The cooling medium flow region 34 is in contact with the grooves and ridges that form the first passages 30 of the first separator 21 and the grooves and ridges that form the second passages 33 of the second separator 22. Therefore, the grooves and ridges forming the first passages 30 of the first separator 21 and the grooves and ridges forming the second passages 33 of the second separator 22 affect the flow of cooling medium in the cooling medium flow region 34.

In each of the first passages 30, which extend in a serpentine path within the first separator 21, sections in which the oxidant gas flow reverses the direction constitute first reversing sections 35, while the sections other than the first reversing sections 35 are referred to as first general sections 36. Each first reversing section 35 extends linearly and is inclined with respect to the short-side direction Y.

In this configuration, each first reversing section 35 extends at an oblique angle such that one end in the short-side direction Y is positioned closer to one side in the long-side direction X than the other end. Preferably, the inclination angle of the first reversing sections 35 relative to the short-side direction Y is acute, and more preferably, it is 45° or less. Each first general section 36 extends in the long-side direction X. Each first general section 36 is a first undulation section 37, which is an example of an undulation section having a wavy shape as a whole.

In each of the second passages 33, which extend in a serpentine path within the second separator 22, sections in which the fuel gas flow reverses the direction constitute second reversing sections 38, while the sections other than the second reversing sections 38 are referred to as second general sections 39. Each second reversing section 38 extends linearly and is inclined with respect to the short-side direction Y.

In this configuration, each second reversing section 38 extends at an oblique angle such that one end in the short-side direction Y is positioned closer to the other side in the long-side direction X than the other end. Preferably, the inclination angle of the second reversing sections 38 relative to the short-side direction Y is acute, and more preferably, it is 45° or less. Each second general section 39 extends in the long-side direction X. Each second general section 39 is a second undulation section 40, which is an example of an undulation section having a wavy shape as a whole.

When the first separator 21 and the second separator 22 are stacked in the thickness direction Z (stacking direction), the first undulation sections 37 of the first general sections 36 of the first passages 30 overlap with the second undulation sections 40 of the second general sections 39 of the second passages 33 with their phase offset from each other in the long-side direction X. In the present example, the phase of the first undulation sections 37 is offset from the phase of the second undulation sections 40 by half a pitch in the long-side direction X.

The first reversing sections 35 of the first passages 30 in the first separator 21 and the second reversing sections 38 of the second passages 33 in the second separator 22 are arranged such that, when viewed in the thickness direction Z (stacking direction), they partially overlap with each other between the cooling medium supplying hole 28 and the cooling medium discharging hole 25, which are disposed opposite to each other in the long-side direction X. In this case, there is no area in which the first passages 30 of the first separator 21 and the second passages 33 of the second separator 22 overlap in parallel alignment when viewed in the thickness direction Z.

### Operation of the Embodiment

As shown in FIGS. 1 to 3, when oxidant gas, fuel gas, and cooling medium are supplied to the fuel cell 11, electric power is generated in each of the single cells 12, which form the fuel cell stack 13. When each single cell 12 generates electric power, oxidant gas is supplied via the oxidant gas supplying hole 27, and fuel gas is supplied via the fuel gas supplying hole 24.

When the oxidant gas is supplied via each oxidant gas supplying hole 27 in the single cell 12, the oxidant gas is supplied to the cathode-side surface of the power generation portion 17 while being diffused by the gas diffusion layer 19 in the process of flowing to the oxidant gas discharging hole 26 through the first passages 30. The oxidant gas that has flowed to the oxidant gas discharging hole 26 is discharged to the outside of the fuel cell stack 13.

On the other hand, when the fuel gas is supplied via each fuel gas supplying hole 24 in the single cell 12, the fuel gas is supplied to the anode-side surface of the power generation portion 17 while being diffused by the gas diffusion layer 19 in the process of flowing to the fuel gas discharging hole 29 through the second passages 33. The fuel gas that has flowed to each fuel gas discharging hole 29 is discharged to the outside of the fuel cell stack 13.

At this time, in each of the single cells 12, electric power is generated based on an electrochemical reaction in the power generation portion 17 between the oxidant gas supplied to the cathode-side surface of the power generation portion 17 and the fuel gas supplied to the anode-side surface of the power generation portion 17.

Each of the single cells 12 generates heat due to power generation by the electrochemical reaction. However, the cooling medium is supplied from the cooling medium supplying hole 28 to the cooling medium flow region 34, which is formed between the first separator 21 of one of two adjacent single cells 12 and the second separator 22 of the other single cell 12 in the fuel cell stack 13.

As shown in FIG. 3, when supplied from the cooling medium supplying hole 28 to the cooling medium flow region 34, the cooling medium tends to flow linearly from the cooling medium supplying hole 28 toward the cooling medium discharging hole 25 through the cooling medium flow region 34. In this state, one end portion of each first reversing section 35 of the first passages 30 of the first separator 21 and one end portion of the corresponding second reversing sections 38 of the second passages 33 of the second separator 22 overlap with each other so as to intersect with each other between the cooling medium supplying hole 28 and the cooling medium discharging hole 25.

Further, each first reversing section 35 extends from an area between the cooling medium supplying hole 28 and the cooling medium discharging hole 25 to an area between the fuel gas discharging hole 29 and the oxidant gas discharging hole 26. Likewise, each second reversing section 38 extends from an area between the cooling medium supplying hole 28 and the cooling medium discharging hole 25 to an area between the oxidant gas supplying hole 27 and the fuel gas supplying hole 24.

Accordingly, some of the cooling medium flowing from the cooling medium supplying hole 28 directly to the cooling medium discharging hole 25 via the cooling medium flow region 34 is guided by the first reversing sections 35 into an area between the fuel gas discharging hole 29 and the oxidant gas discharging hole 26, and is also guided by the second reversing sections 38 into an area between the oxidant gas supplying hole 27 and the fuel gas supplying hole 24.

As a result, in the cooling medium flow region 34, the following three flows of the cooling medium are formed: a flow from the cooling medium supplying hole 28 to the cooling medium discharging hole 25; a flow toward the oxidant gas discharging hole 26 through the area between the fuel gas discharging hole 29 and the oxidant gas discharging hole 26; and a flow toward the fuel gas supplying hole 24 through the area between the oxidant gas supplying hole 27 and the fuel gas supplying hole 24.

That is, the cooling medium flows through the cooling medium flow region 34 from the cooling medium supplying hole 28 toward the cooling medium discharging hole 25 while being dispersed in the short-side direction Y. In other words, the cooling medium is distributed more uniformly across the entire cooling medium flow region 34. As a result, the entire single cell 12 is uniformly cooled by the cooling medium. This reduces variations in cooling effectiveness of the cooling medium across the single cell 12. The cooling medium that reaches each cooling medium discharging hole 25 is discharged to the exterior of the fuel cell stack 13.

### Advantages of the Embodiment

The above-described embodiment achieves the following advantages.

(1) The fuel cell stack 13 includes the stacked single cells 12. Each single cell 12 has a shape of a rectangular plate with first sides and second sides. Each single cell 12 includes the power generation portion 17, the first separator 21, and the second separator 22. The first separator 21 and the second separator 22 sandwich the power generation portion 17. Each single cell 12 includes, at one end in the long-side direction X, the fuel gas supplying hole 24, to which fuel gas is supplied, the cooling medium discharging hole 25, through which cooling medium is discharged, and oxidant gas discharging hole 26, through which the oxidant gas is discharged. Further, each single cell 12 includes, at the other end in the long-side direction X, the oxidant gas supplying hole 27, to which oxidant gas is supplied, the cooling medium supplying hole 28, to which cooling medium is supplied, and the fuel gas discharging hole 29, through which fuel gas is discharged. The fuel gas supplying hole 24, the cooling medium discharging hole 25, and the oxidant gas discharging hole 26 are arranged in that order from one side to the other side in the short-side direction Y of the single cell 12. The oxidant gas supplying hole 27, the cooling medium supplying hole 28, and the fuel gas discharging hole 29 are arranged in that order from one side to the other side in the short-side direction Y of the single cell 12. The first separator 21 includes grooves and ridges integrally formed on the opposite sides. The grooves and ridges define the meandering first passages 30, in which flow of oxidant gas is reversed multiple times. The first passages 30 extend from the oxidant gas supplying hole 27 to the oxidant gas discharging hole 26 and supply the oxidant gas to the surface on one side of the power generation portion 17. The second separator 22 includes grooves and ridges integrally formed on the opposite sides. The grooves and ridges define the meandering second passage 33, in which flow of fuel gas is reversed multiple times. The second passages 33 extend from the fuel gas supplying hole 24 to the fuel gas discharging hole 29 and supply the fuel gas to the surface on the other side of the power generation portion 17. The cooling medium flow region 34, in which the cooling medium flows from the cooling medium supplying hole 28 toward the cooling medium discharging hole 25, is formed between the first separator 21 of one of two single cells 12 adjacent to each other in the thickness direction Z and the second separator 22 of the other single cell 12. The first reversing sections 35 of the first passages 30 and the second reversing sections 38 of the second passages 33 extend to be inclined with respect to the short-side direction Y. The first reversing sections 35 of the first passages 30 and the second reversing sections 38 of the second passages 33 overlap with each other so as to intersect with each other between the cooling medium supplying hole 28 and the cooling medium discharging hole 25, which are disposed opposite to each other in the long-side direction X when viewed from the thickness direction Z.

Generally, the grooves and ridges that define the first passages in the first separator and the second passages in the second separator are formed integrally on the opposite sides of the respective separators. These grooves and ridges create flow resistance when cooling medium flows through the cooling medium flow region. The first passages and the second passages are meandering passages with general sections extending in the first direction (long-side direction X) and the reversing sections extending in the second direction (short-side direction Y). In such a configuration, the cooling medium tends to flow from the cooling medium supplying hole to the cooling medium discharging hole through the cooling medium flow region. However, in a state in which the first passages and the second passages are parallel to each other, if the grooves and ridges in the reversing sections overlap with each other in the cooling medium flow region between the cooling medium supplying hole and the cooling medium discharging hole, the cooling medium does not flow through the portions where the grooves and ridges overlap each other. Consequently, the effectiveness of cooling by the cooling medium varies significantly across each single cell.

In this regard, according to the above-described configuration, the first reversing sections 35 of the first passages 30 and the second reversing sections 38 of the second passages 33 extend to be inclined with respect to the short-side direction Y. Also, the first reversing sections 35 and the second reversing sections 38 overlap with each other so as to intersect with each other between the cooling medium supplying hole 28 and the cooling medium discharging hole 25, which are disposed opposite to each other in the long-side direction X when viewed from the thickness direction Z. Therefore, the first passages 30 and the second passages 33 do not overlap with each other in a state in which the grooves and ridges in the first reversing sections 35 and the second reversing sections 38 are parallel to each other in the cooling medium flow region 34 between the cooling medium supplying hole 28 and the cooling medium discharging hole 25. Therefore, the cooling medium is not prevented from flowing from the cooling medium supplying hole 28 to the cooling medium discharging hole 25 in the cooling medium flow region 34. In addition, the first reversing sections 35 of the first passages 30 and the second reversing sections 38 of the second passages 33 guide some of the cooling medium supplied via the cooling medium supplying hole 28 to the opposite sides in the short-side direction Y of the cooling medium flow region 34. Accordingly, the cooling medium is distributed uniformly across the cooling medium flow region 34. This reduces variations in cooling effectiveness of the cooling medium across the single cell 12.

(2) In the fuel cell stack 13, the first reversing sections 35 of the first passages 30 and the second reversing sections 38 of the second passages 33 extend linearly.

According to this configuration, the first reversing sections 35 of the first passages 30 and the second reversing sections 38 of the second passages 33 smoothly guide some of the cooling medium supplied via the cooling medium supplying hole 28 to the opposite sides in the short-side direction Y of the cooling medium flow region 34.

(3) In the fuel cell stack 13, the first general sections 36 of the first passages 30 are the first undulation sections 37, which have wavy shapes. Also, the second general sections 39 of the second passages 33 are the second undulation sections 40, which have wavy shapes. When the first separator 21 and the second separator 22 are stacked together, the phase of the first undulation sections 37 of the first passages 30 and the phase of the second undulation sections 40 of the second passages 33 are offset from each other.

With this configuration, the phase offset between the first undulation sections 37 of the first passages 30 and the second undulation sections 40 of the second passages 33 enables the cooling medium to flow not only in the long-side direction X but also in the short-side direction Y in the areas corresponding to the first general sections 36 of the first passages 30 and the second general sections 39 of the second passages 33 within the cooling medium flow region 34.

(4) In the fuel cell stack 13, the first separator 21 and the second separator 22 have an identical configuration.

According to this configuration, since the first separator 21 and the second separator 22 can be the same component, the number of components can be reduced as compared with the case in which the first separator 21 and the second separator 22 are different components.

### Modifications

The above-described embodiment may be modified as follows. The above-described embodiment and the following modifications can be combined as long as the combined modifications remain technically consistent with each other.

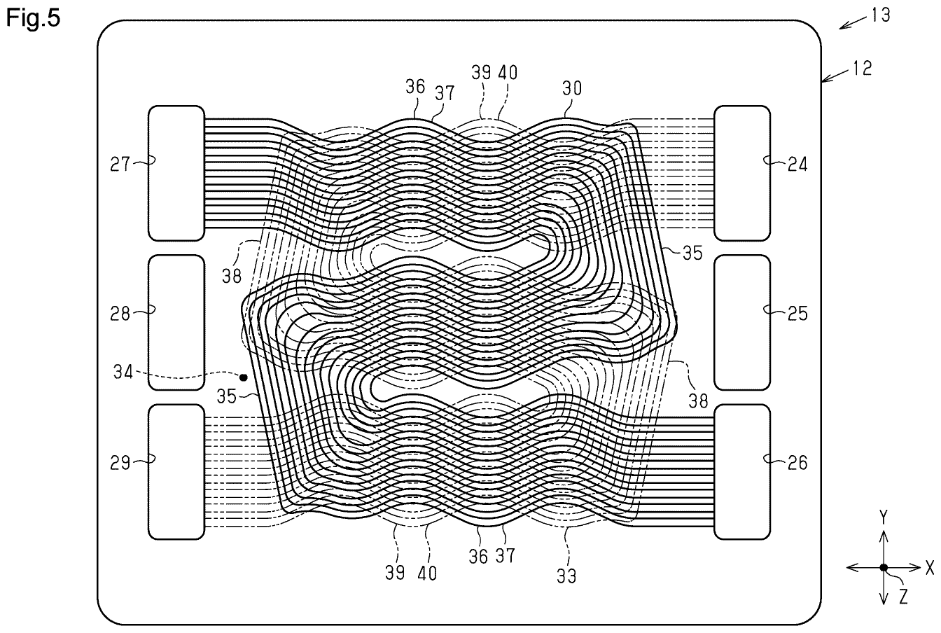

As shown in FIG. 5, the first reversing sections 35 and the second reversing sections 38 may extend so as to be inclined with respect to the short-side direction Y to the sides opposite to those in the case of the above-described embodiment.

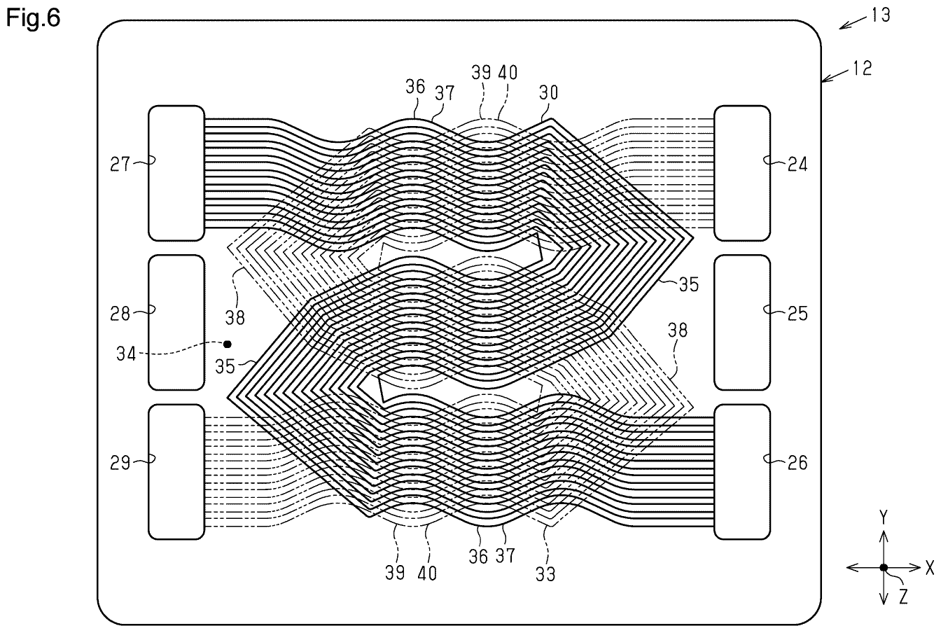

As shown in FIG. 6, the first reversing sections 35 and the second reversing sections 38 may each be bent and extend in an L shape so as to be inclined with respect to the short-side direction Y.

The first separator 21 and the second separator 22 do not necessarily need to have an identical configuration. That is, the first separator 21 and the second separator 22 may have different configurations.

The first general sections 36 of the first passages 30 do not necessarily need to be the first undulation sections 37, which have wavy shapes. Also, the second general sections 39 of the second passages 33 do not necessarily need to be the second undulation sections 40, which have wavy shapes. That is, the first general sections 36 and the second general sections 39 may extend, for example, linearly.

The first reversing sections 35 and the second reversing sections 38 do not necessarily have to extend linearly. That is, the first reversing sections 35 and the second reversing sections 38 may extend so as to form wavy shapes, for example.

The position of the oxidant gas discharging hole 26 and the position of the oxidant gas supplying hole 27 may be interchanged. That is, the third hole may be the oxidant gas supplying hole 27, and the fourth hole may be the oxidant gas discharging hole 26.

The position of the fuel gas supplying hole 24 and the position of the fuel gas discharging hole 29 may be interchanged. That is, the first hole may be the fuel gas discharging hole 29, and the sixth hole may be the fuel gas supplying hole 24.

The position of the cooling medium supplying hole 28 and the position of the cooling medium discharging hole 25 may be interchanged. That is, the second hole may be the cooling medium supplying hole 28, and the fifth hole may be the cooling medium discharging hole 25.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising multiple stacked single cells, wherein
each of the single cells has a shape of a rectangular plate with a first side and a second side that are orthogonal to each other, and includes a power generation portion, a first separator and a second separator, the first separator and the second separator sandwiching the power generation portion,
each of the single cells includes:
a first hole, a second hole, and a third hole at an end portion on one side in a first direction, the first direction being a direction in which the first side extends; and
a fourth hole, a fifth hole, and a sixth hole at an end portion on an other side in the first direction,
the first hole, the second hole, and the third hole are arranged in that order from one side to the other side in a second direction, the second direction being a direction in which the second side extends,
the fourth hole, the fifth hole, and the sixth hole are arranged in that order from the one side to the other side in the second direction,
one of the first hole and the sixth hole is a fuel gas supplying hole to which fuel gas is supplied, and the other is a fuel gas discharging hole through which the fuel gas is discharged,
one of the third hole and the fourth hole is an oxidant gas supplying hole to which oxidant gas is supplied, and the other is an oxidant gas discharging hole through which the oxidant gas is discharged,
one of the second hole and the fifth hole is a cooling medium supplying hole to which a cooling medium is supplied, and the other is a cooling medium discharging hole through which the cooling medium is discharged,
the first separator includes grooves and ridges integrally formed on opposite sides, the grooves and ridges defining meandering first passages in which a flow of the oxidant gas is reversed multiple times, the first passages extending from the oxidant gas supplying hole to the oxidant gas discharging hole and supplying the oxidant gas to a surface on one side of the power generation portion,
the second separator includes grooves and ridges integrally formed on opposite sides, the grooves and ridges defining meandering second passages in which a flow of the fuel gas is reversed multiple times, the second passages extending from the fuel gas supplying hole to the fuel gas discharging hole and supplying the fuel gas to a surface on an other side of the power generation portion,
a cooling medium flow region through which the cooling medium flows from the cooling medium supplying hole toward the cooling medium discharging hole is formed between the first separator of one of two single cells adjacent to each other in a stacking direction and the second separator of the other of the two single cells,
the first passages each include a reversing section, and the second passages each include a reversing section, the reversing sections of the first passages and the reversing sections of the second passages extending to be inclined with respect to the second direction, and
when viewed from the stacking direction, the reversing sections of the first passages and the reversing sections of the second passages overlap with each other so as to intersect with each other between the cooling medium supplying hole and the cooling medium discharging hole, which are disposed opposite to each other in the first direction.

2. The fuel cell stack according to claim 1, wherein the reversing sections of the first passages and the reversing sections of the second passages extend linearly.

3. The fuel cell stack according to claim 1, wherein
each of the first passages includes a general section that is a section other than the reversing section, the general section being an undulation section having a wavy shape,
each of the second passages includes a general section that is a section other than the reversing section, the general section being an undulation section having a wavy shape, and
when the first separator and the second separator are stacked together, a phase of the undulation sections of the first passages and a phase of the undulation sections of the second passages are offset from each other.

4. The fuel cell stack according to claim 1, wherein the first separator and the second separator have an identical configuration.
